(19) United States
(12) Patent Application Publication
(10) Pub. No.: US 2005/0225302 A1
(43) Pub. Date: Oct. 13, 2005

(54) Generator system and method for operating such a system

(75) Inventors: Maurus Herzog, Schinznach-Dorf (CH); Michael Hiegemann, Rufenach (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ALSTOM Technology Ltd, Baden (CH)

(21) Appl. No.: 11/094,672

(22) Filed: Mar. 31, 2005

(30) Foreign Application Priority Data
Mar. 31, 2004 (DE) 10 2004 016 461.4

(51) Int. Cl. H02H 7/06; H02P 9/00; H02P 11/00; H02P 9/10

(52) U.S. Cl. 322/29

(57) ABSTRACT

The invention relates to a generator system for generating an increased braking power, in particular during the startup and/or powering down of a turbine, drivingly connected to a generator, of a turbine system, e.g. a CAES system. The generator system includes the generator, which for generating current is drivingly connected to the turbine, and a transformer, which is connected on the primary side to the generator and on the secondary side to an external current network. A means for frequency adaptation is disposed between the generator and the transformer and is expediently embodied as capable of being put on line. By putting the means for frequency adaptation on line during the startup and/or the powering down of the turbine system, the turbine is acted upon by a greater braking power. In this way, the development of ventilation in the turbine can be largely avoided.

### RELATED APPLICATIONS

This application claims priority to Application No. 10 2004 016 461.4, filed in Germany on 31 Mar. 2004, which is hereby incorporated by reference in its entirety.

### FIELD OF THE INVENTION

The invention relates to a generator system, which for generating current is driven by a turbine of a turbine system, in particular a turbine of a CAES system. The invention also relates to a method for operating such a generator system, particular during a nonsynchronized mode of operation of the turbine.

### PRIOR ART

Modern turbine systems used in the German Power Plant Association for generating current should be capable of being started up from a stop to the rated rpm in the shortest possible time, in order to assure high operational readiness of the system. Especially turbine systems that are used to cover a peak load are especially subject to this requirement. For this kind of peak load coverage, in recent times compressed air energy storage systems (or CAES systems for short) have increasingly been provided, which because of their conception in turn make particular demands of the starting process.

The fundamental concept of such CAES systems is for excess energy, which is generated by conventionally operated power plants for covering the basic load during low-load times at a low current price, to be stored. This is attained by pumping air or some other gas into a reservoir at a relatively high pressure with the aid of the excess energy. From this reservoir, the air or gas can then be withdrawn again, for instance to cover a peak load demand.

The basic layout of such a CAES system is shown in FIG. 1b and includes a gas reservoir, in which a gas can be stored under pressure; a turbine group, which has at least one turbine; a generator, which is drivingly connected to the turbine via a shaft; as well as connecting lines and shutoff elements. As the gas reservoir, it is possible for instance to use a retired coal, limestone or salt mine.

In contrast to conventional gas turbine systems, the turbine of a CAES system, however, is not drivingly connected to a compressor. Typically, the turbine is merely coupled to the generator via a shaft. During the startup of the CAES system, the turbine rpm is not synchronous with the frequency of the current network into which the generated current is fed. In this nonsynchronized operating state, the generator is typically decoupled from the external current network. Coupling between the generator and the external current network is as a rule not done until after a startup of the turbine to a rated rpm, at which synchronization with the external current network is possible.

Consequently, during the startup process, often the only braking force is furnished by the ventilation losses from the turbines and the bearing friction losses from the turbine and the generator, which in modern systems are usually very slight. As a result, at even a slight air flow rate, the turbine is already speeded up to high rotary speeds, at which in turn, in the farther-downstream turbine stages, ventilation effects ensue because the air flow rate is not yet high enough. The ventilation caused by the slight air flow rate leads to unusual mechanical and thermal loads, particularly on the blades of the turbine. The slight air flow rate can also, as described in International Patent Application WO 03 076 780, lead to a nonstatic behavior of the turbine.

Such problems also occur in conventional power plants, however, on startup of the system, before the system is synchronized with the external current network.

In powering down of CAES systems or turbines or turbine systems in conventional power plants as well, a suitable braking force is as a rule absent immediately after the decoupling from the external current network.

In steam turbines, particularly during the startup process, the demands on the part of the steam generator must additionally be taken into account at the same time. In air turbines, the turbine may be preceded by one or more recuperators or combustion chambers, which then lead to further restrictions in operation.

To remedy this, for instance in steam power plants, conventionally one or more bypasses are often provided, with the aid of which the amount of steam furnished by a steam boiler can be made to bypass a high-pressure part and/or a medium-pressure part and/or a low-pressure part of the steam turbine either entirely or in part. As a result, the demands in terms of the boiler may be brought into agreement with those for the turbine. In terms of the turbine, power production in the high- and/or medium- and/or low-pressure part is reduced and adapted to the ventilation power dissipated in the partial turbines, bearings, and other connected equipment, so as to avoid an unwanted increase in rpm. However, because of the requisite dimensioning of the pipelines and fittings, bypasses are expensive and perform no function once the system has been run up to speed. Moreover, the startup process is delayed by various limitations of the temperature gradients in the partial turbines. Thus an adequate amount of steam would often already be available at a much earlier time yet cannot be fully utilized because of the tedious startup process.

Accordingly, upon startup of a CAES system or other kind of power system, particular care must also often be taken to assure that the components disposed in or bordering on the blade mounting channel will be brought to operating temperatures in a controlled way adapted to one another. This is necessary, in order to avoid unwanted thermal expansions of the components and impermissible thermal stresses on the components as a consequence of the temperature change caused by the flow supplied to the blade mounting channel. It should therefore be possible even before the synchronization to pass the largest possible flow quantity of steam or air through the entire blade mounting channel of the turbine train.

To attain this, particularly in power plants in which air turbines are employed, because of the lack of a significant braking power in the system, additional brakes that can be put on line must be provided. In WO 03 076 780, for instance, the use of a static frequency converter which can be coupled with the generator is described. With the aid of the frequency converter, a variable braking moment is generated and exerted on the shaft via the generator. The frequency converters used in such arrangements are very expensive, however, and once again have no function once this system has been run up to speed.

### SUMMARY OF THE INVENTION

The invention seeks to remedy this. It is accordingly the object of the invention to disclose an apparatus and a method of the type defined at the outset with which the disadvantages of the prior art can be lessened or avoided.

In particular, the invention intends to contribute to making it possible for a turbine system used for generating current, in particular a turbine system in a CAES system, to be started up and/or powered down in a short time, with the development of ventilation extensively avoided. In a further aspect, the invention is also expediently intended to contribute to making the most extensive possible utilization of the electrical energy generated by the turbine system possible. In still another aspect, the invention is meant to create an additional degree of freedom in designing a turbine system, particularly with a view to transient operating states of the system, such as startup or powering down of the system.

This object is attained according to the invention by the generator system as defined by claim 1 and by the method as defined by the independent method claim. Other advantageous features of the invention are defined by the dependent claims.

The invention makes a generator system for use in a turbine system, in particular in a CAES system, available. The generator system of the invention includes a generator, which for generating current is mechanically connected to a turbine via a shaft, and a transformer, which is connected to the generator on the primary side and can be connected to an external current network on the secondary side. In addition, a means for frequency adaptation is moreover disposed between the generator and the transformer.

The generators known from the prior art are typically disconnected from the transformer during the startup and/or powering down of the turbine drivingly connected to the generator. For that purpose, a disconnection switch is as a rule disposed in the connecting line between the generator and the transformer. The switch may also be disposed between the transformer and the external current network. As already discussed above, until now, for instance during startup and/or powering down, it has been necessary to disconnect the generator from the transformer, since during these operating states the turbine is not synchronized with the external current network. Once the generator is disconnected from the transformer, however, there is only a slight braking moment, which can essentially be ascribed to the bearing friction.

Conversely, if in accordance with the invention a means for frequency adaptation is disposed between the generator and the transformer, then it is unnecessary to disconnect the generator from the transformer during nonsynchronized operating states of the turbine drivingly connected to the generator. Although here again the frequency of the alternating current, or multiphase alternating current, generated by the generator does not match the frequency of the current network connected to it, nevertheless the means for frequency adaptation adapts the frequency of the generated current to the frequency of the connected current network. The generated current can thus be fed into the connected current network, regardless of the operating state of the turbine system—and hence even during startup and/or powering down of the turbine system. It has been demonstrated from this that the generator, by feeding the generated current into the connected current network during startup and/or powering down of the turbine system, generates a markedly increased braking moment than when the generator is disconnected from the transformer. A higher braking moment means that the increase in the load on the turbine system during the startup can be made more uniform. In a further aspect, upon startup of the turbine system, a greater amount of flowing fluid can already be passed through the turbine earlier, further shortening the duration of startup. An increased flow rate of the flowing fluid simultaneously reduces the development of ventilation in farther-downstream turbine stages or downstream turbines. Because the load increase is made uniform, the turbine system can overall be run up to speed within a shorter time.

The turbine system can also be powered down faster. Critical rpm ranges in which natural oscillations of components for instance occur can be gone through faster than was possible previously, because of the shortening of the duration of the startup operation and powering down operation and because of the good regulability of these processes.

Moreover, because of the embodiment of the generator system according to the invention, the current generated by the generator can already be fed into an external or even an internal current network even during the startup process of the connected turbine. Similarly, on powering down of the turbine, the current also generated during the powering down can still be fed to the external or internal current network. This represents a direct commercial advantage over the versions known from the prior art.

As the means for frequency adaptation, a frequency converter, in particular a static frequency converter, is expediently used.

Moreover, in a preferred feature of the invention, the means for frequency adaptation can be put on line. Thus the means for frequency adaptation can be put on line in a controlled fashion as needed, for instance by a control unit, and put off-line again, with the above-described positive effects on the operating performance of the turbine system. Thus as a rule it will be expedient to put the means for frequency adaptation off-line, in the synchronized state of the turbine system.

The turbine system may include one or more turbines, which are drivingly connected to the generator via a shaft. The turbines of the turbine system may each be embodied as steam turbines and/or air turbines, or a combination thereof, or as turbines designed in some other way. The generator is expediently designed in a known manner as a synchronous generator.

The generator system embodied according to the invention can in principle be drivingly connected to any type of engine, such as a piston engine or a turbine engine. Particular advantages in terms of regulating the operating parameters are attained, however, when the generator wiring is applied to turbine systems of the type discussed at the outset. In that case, the invention creates a further degree of freedom in designing the startup operation as well as the braking down operation upon powering down of the turbine system. This is of very great utility, because of the increasingly critical further parameters, such as the steam temperature, blade length, material of the final stage, and so forth, that affect the startup process and/or the braking down process.

In a preferred refinement of the invention, the generator and the transformer are connected to one another via a connecting line. The means for frequency adaptation is then expediently disposed such that it can be put on line into the connecting line. Regardless of whether the means for frequency adaptation is put on line now or not, in this preferred refinement of the invention the current generated by the generator is carried to the transformer and from there is carried away into the external current network.

To make it possible to put the means for frequency adaptation on line in the connecting line, a first disconnection element is for instance expediently disposed in the connecting line. The means for frequency adaptation can then advantageously be disposed in a bypass line, which bypasses the first disconnection element, and a second disconnection element is also disposed in the bypass line. By opening the first disconnection element, disposed in the connecting line, and simultaneously closing the second disconnection element, disposed in the bypass line, the means for frequency adaptation can thus be put on line in a simple way or also, by reverse switching logic, put off-line again.

The disconnection elements are expediently embodied as disconnection switches. It will usually be expedient for the disconnection switches to be controlled by means of a control unit.

In an alternative or a supplementary refinement, the generator and the transformer are also connected to one another via the connecting line. The first disconnection element is also disposed in the connecting line. Here, however, the means for frequency adaptation is disposed in a branch line that can be put on line in the connecting line and that branches off from the connecting line or the generator in a region between the generator and the first disconnection element. Expediently, a further, second disconnection element is disposed in the branch line, and by way of it the branch line can be put on line. Once again, both disconnection elements are advantageously embodied as disconnection switches.

If the means for frequency adaptation is not put on line, then current that is generated by the generator is carried to the transformer via the connecting line and from the transformer is carried away into the external current network. The first disconnection element disposed in the connecting line is closed, but the second disconnection element disposed in the branch line is open. If conversely the means for frequency adaptation is put on line, then the generated current is carried into the branch line. The switching positions of the disconnection elements are the reverse of the switching position described before; that is, the first disconnection element is open and the second disconnection element is closed.

Expediently, the branch line communicates with an internal current network, to cover the internal demand of the generator system and/or of the turbine system. Thus the current demand of the generator system and/or the turbine system during the startup and/or powering down of the turbine system can be furnished partially or even completely internally.

To achieve this kind of internal power supply, a further transformer is expediently disposed between the means for frequency adaptation and the internal current network.

In most turbine systems installed at present, retrofitting with a generator system according to the invention is simple to do. Often, all that is needed is to augment the existing generator system of the turbine system in a suitable way.

In many applications, it will be expedient for a turbine system, along with a generator system embodied according to the invention, also to be equipped with a regulatable bypass, in order to carry some of a flowing fluid past at least one turbine or partial turbine of the turbine system. By combining the generator system of the invention with a regulatable bypass, there are two controlled variables, as degrees of freedom for the regulation, available for regulating the startup process of the turbine system. With a combined disposition of the generator system embodied according to the invention and additionally the bypass, the bypass can be made smaller in size and thus more economical in terms of investment than would be possible without the generator system embodied according to the invention.

In a further aspect, the invention makes a method available for operating a generator system, in particular the above-described generator system according to the invention. To that end, as discussed above, the generator system includes a generator, which for generating current is driven by a turbine of a turbine system, in particular a turbine of a CAES system. The electrical power generated by the generator during a nonsynchronized mode of operation of the generator is, according to the method of the invention, initially frequency-adapted before the generated power is carried away into a current network.

The current network into which the electrical power is carried away can expediently be an external current network.

However, the current network into which the electrical power is carried away can also be an internal current network, for internally supplying the generator system and/or the turbine system.

The method of the invention comes into use particularly during the startup and/or powering down of the turbine.

Expediently, the frequency adaptation upon startup of the turbine is ended once synchronizing of the turbine with the external current network has been accomplished. As a result, no electrical losses, caused by the frequency adaptation, occur in the synchronized operating mode of the system.

On powering down of the turbine, the frequency adaptation is expediently ended when a limit rpm of the turbine is undershot, and the generator is disconnected from the transformer.

### BRIEF DESCRIPTION OF THE DRAWINGS

The invention will be described in further detail below in terms of two exemplary embodiments, which are shown in the drawings. Shown are:

FIG. 1a, a turbine system, known from the prior art, with a generator;

FIG. 1b, a CAES system known from the prior art;

FIG. 1c, a steam turbine system known from the prior art;

FIG. 2, a first generator system embodied according to the invention;

FIG. 3, a further generator system embodied according to the invention;

FIG. 4, a further generator system embodied according to the invention.

In the drawings, only those elements and components that are essential to understanding the invention are shown.

The exemplary embodiments shown should be understood as purely instructive and are intended to serve the purpose of better understanding but not as a restriction of the subject of the invention.

### Ways of Embodying the Invention

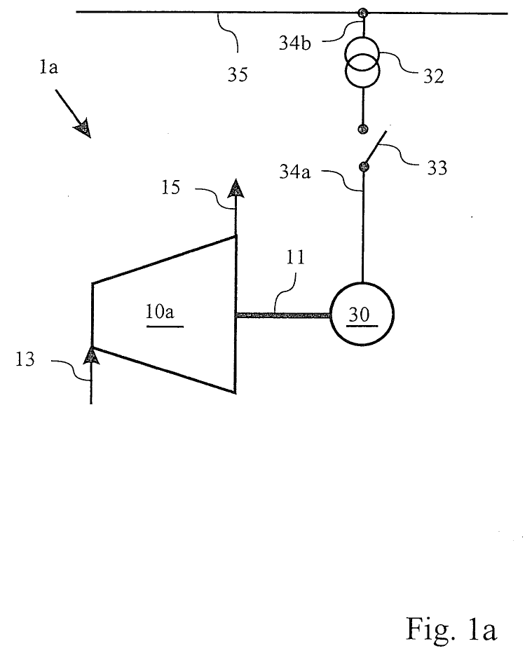

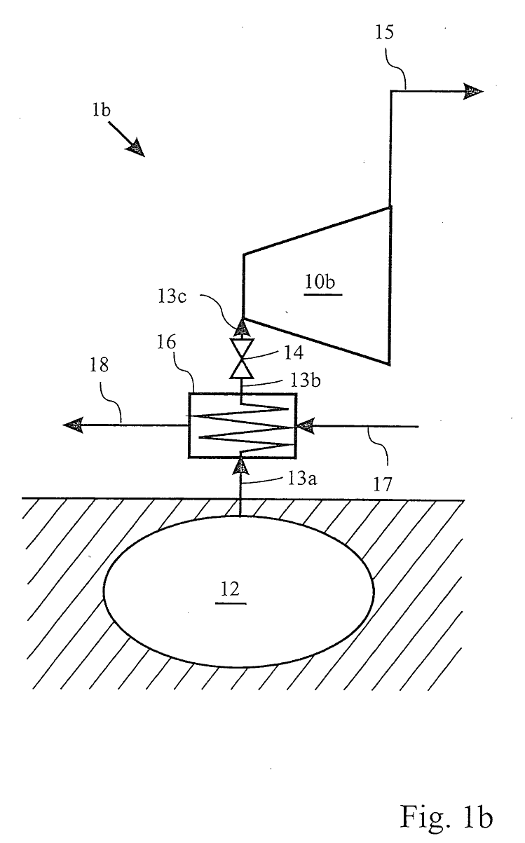

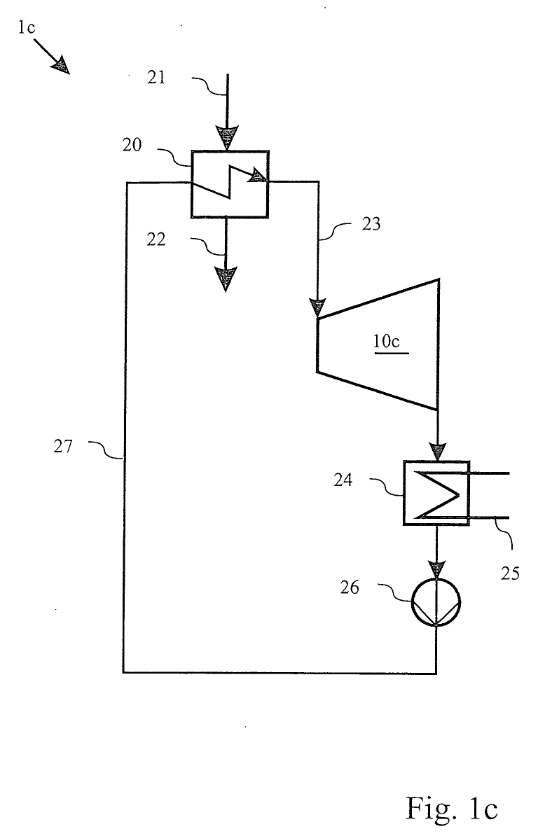

In FIG. 1a, the layout of a turbine system 1a known from the prior art is shown schematically. The turbine system 1a may for instance be a steam turbine system or a CAES system.

The turbine system 1a includes a turbine 10a, to which a flowing fluid is delivered via a supply line 13. After flowing through the turbine 10a, the fluid is carried away at the outlet from the turbine 10a via the outgoing line 15. The turbine 10a shown here may be embodied as an air turbine, a gas turbine, a steam turbine, or a turbine embodied in some other way. Depending on the type of turbine, the flowing fluid is either air, a flue gas and air mixture, steam, or some other kind of fluid.

In flowing fluid of the turbine 10a, the flowing fluid expands, producing technical work, by which the rotor of the turbine 10a and the shaft 11 connected to the rotor are set into rotary motion. This rotary motion is transmitted via the shaft 11 to a rotor of the generator 30. By means of the rotary motion of the rotor, the generator generates current in a known manner.

The generator is connected to an external current network 35 via the connecting lines 34a and 34b, an interrupt switch 33, and a transformer 32. When the interrupt switch 33 is closed, the current generated by the generator is carried away to the external current network 35 via the current-carrying lines 34a and 34b and the transformer 32.

To close the interrupt switch 33, it is typically necessary that the turbine 10a be run up to speed and be operated in an operating state that is synchronized with the external current network 35. During the startup of the turbine 10a as well as during the powering down of the turbine 10a, conversely, the operation of the turbine 10a is not synchronized with the external current network 35. The frequency of the current generated by the generator during these operating states is accordingly also not synchronous with the frequency of the external current network. Hence the current generated during these operating states cannot be carried away into the external current network. Both for startup of the turbine 10a and powering down of the turbine 10a, the interrupt switch 33 is therefore typically opened.

Once the interrupt switch 33 is open, the generator 30 also generates no braking moment, or only a very slight braking moment. Accordingly, both during startup and powering down of the turbine 10a, with the interrupt switch 33 open, essentially only the comparatively slight friction losses of the bearings act as a braking moment on the turbine 10a.

In many cases, this means that even a slight flow rate of the fluid flowing through the turbine 10a suffices to accelerate the rotor of the turbine 10a, along with the shaft 11, to high rotary speeds. Because of the high rotary speeds yet simultaneously with an only slight flow rate of flowing fluid, a ventilation of the flow often occurs in the farther-downstream stages of the turbine 10a. The ventilation of the flow in turn leads to a high but usually atypical mechanical load on the blades of the turbine 10a.

For attaining a rapid temperature equalization as well, it is desirable to have the highest possible air flow rate through the turbine 10a at an early stage in the startup.

This problem exists upon startup and powering down of the turbine systems shown in FIGS. 1b and 1c.

FIG. 1b schematically shows a CAES system 1b (CAES stands for Compressed Air Energy Storage) known from the prior art. CAES systems of this type are known for instance from the paper entitled “CAES—Reduced to Practice” by J. Daly, R. M. Loughlin von Dresser-Rand, M. DeCorso, D. Moen, and L. Davis, which was presented at the ASME Turbo Expo 2001.

The CAES system 1b shown in FIG. 1b includes a gas reservoir 12, in which a gas, such as air, can be stored under pressure. A retired coal, limestone or salt mine may be used as the gas reservoir. The CAES system 1b furthermore here includes one air turbine 10b. However, more than one turbine may also be connected in series here.

The gas reservoir 12 and the air turbine 10b are connected to one another via a connecting line, which is subdivided here into three individual lines 13a, 13b and 13c. Between the individual lines 13b and 13c, a shutoff valve 14 for throttling or shutting off the flow out of the gas reservoir 12 is also integrated. The air turbine 10b is also adjoined by a line 15, which for instance leads to a further turbine or another consumer or which as a drain line also communicates with the environment.

As shown in FIG. 1b, a heat exchanger or recuperator 16 may also be interposed in the connecting line, upstream of the air turbine 10b, if an elevation of the temperature of the stored gas is necessary. In the heat exchanger or recuperator 16, the air arriving from the gas reservoir 12 is preheated. To that end, a warmer fluid, such as air, is delivered to the heat exchanger or recuperator 16 via the supply line 17 and is drained away again via the drain line 18 after flowing through the heat exchanger or recuperator 16. The heating of the stored gas may also be done by combustion of fuel in a combustion chamber interposed into the connecting line. A further variant is for the gas to be passed through a regenerative reservoir that was brought to operating temperature beforehand. The heating may also be done in a combination of these components. The recuperator shown in FIG. 1b acts as a representative of one of the components or of a combination of these elements.

Not shown in FIG. 1b is a generator connected to the turbine 10b. The disposition of a generator and the connection of the generator to an external current network is equivalent to the description of FIG. 1a and will therefore not be described again in detail here.

As in the description of FIG. 1a, the CAES system 1b is operated both during startup and during powering down of the system 1b in a state that is not synchronized with the external current network 35. Here again, the interrupt switch disposed in the connecting line to the external current network is therefore open. As already described above, upon startup and powering down only a comparatively slight braking moment therefore acts on the turbine 10b, with the resultant consequences described above.

FIG. 1c shows a steam turbine system 1c known from the prior art. The steam generated in a steam generator 20 is delivered via the supply line 23 to the steam turbine 10c, in which the steam is expanded, outputting technical work. The steam emerging from the steam turbine 10c then reaches a condenser 24, in which the steam is condensed by heat exchange, by means of the cooling fluid delivered via the heat exchanger line 25. The condensate then reaches the condensate pump 26. The condensate pump 26 pumps the condensate into the line 27, by way of which the condensate is returned to the steam generator 20. For evaporating the condensate, a hot fluid is delivered to the steam generator 20 via the line 21 and effects the evaporation of the condensate by way of heat exchange in the heat exchanger 20. The exhaust gas from a parallel-operated gas turbine process may for instance be used as the hot fluid. After the heat exchange, the hot fluid delivered to the heat exchanger is drained out of the heat exchanger 20 via the drain line 22.

FIG. 1c does not show the disposition of a generator connected to the turbine 10c. Both the disposition of a generator and the connection of the generator to an external current network are equivalent to the description of FIG. 1a and will therefore not be described here again in detail.

In conjunction with the steam turbine system 1c shown in FIG. 1c as well, the above-described problems arise upon startup and powering down of the turbine 10c.

For solving these problems upon startup and powering down of turbines, WO 03 076 780 for instance proposes additionally connecting a static frequency converter to the generator. According to WO 03 076 780, the static frequency converter is connected to the generator via a shaft. The static frequency converter can be triggered as needed such that a braking moment is generated, which is transmitted via the shaft of the connected turbine. The shaft rpm can thus be regulated to optimal rotary speeds for the applicable operating state in a way controlled by braking moment even during the startup process or powering down process of the turbine or turbines of a turbine system.

Alternatively or in addition, it is also known here to provide a bypass, to cause the flowing fluid to bypass the turbine in part or even completely.

Both versions known from the prior art are, however, very cost-intensive and perform no function once the system has run up to speed. Nor is the current generated during the startup and/or during the powering down of the system made use of at all. Instead, for operating the static frequency converter, further current that must be furnished externally is employed.

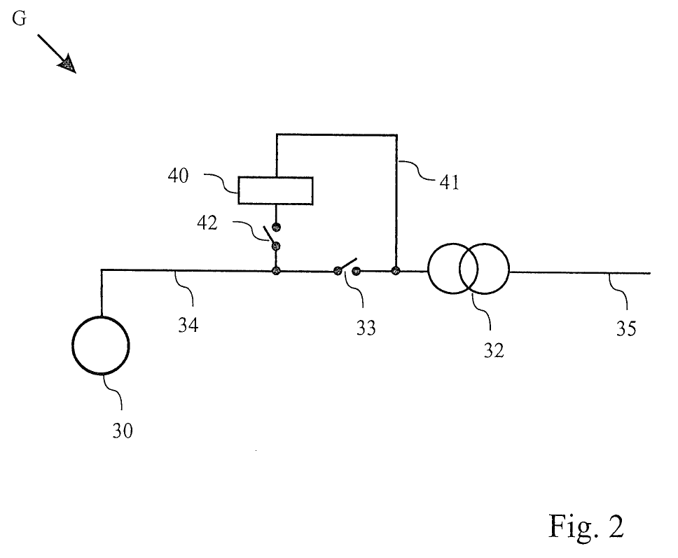

FIG. 2 shows a first embodiment of the generator system according to the invention. The generator system shown here could for instance be embodied as part of the turbine systems shown in FIGS. 1a through 1c.

The generator system G shown in FIG. 2 includes a generator 30, in this case a synchronous generator, which for generating current is drivingly connected to a turbine. Expediently, the generator is connected to the turbine in a manner fixed against relative rotation via a shaft. The generator system further includes a transformer 32, which is connected to the generator 30 on the primary side via the connecting line 34 and to an external current network 35 on the secondary side. (The line designated by reference numeral 35 in FIG. 2, in the strict sense, represents only a supply line to the external current network. To simplify the description, however, the supply line 35 is hereinafter usually considered to be equivalent to the external current network.) In the state in which the turbine system has run up to its operating speed, the current generated by the generator 30 delivered via the connecting line 34 to the transformer 32, where it is transformed to a voltage adapted to the external current network, before the current is fed into the external current network 35. In multiphase generators, each phase accordingly communicates with the line for that phase of the network. This observation applies logically to all the other versions as well.

In the state in which the system has been run up to operating speed, the turbine is operated in synchronization with the external current network 35. During the runup to speed or the powering down of the turbine, conversely, the turbine is in a nonsynchronized state relative to the external current network. As already described in conjunction with FIGS. 1a through 1c, the disconnection switch 33 disposed in the connecting line is therefore conventionally opened both for startup of the turbine and for powering down of the turbine. Hence conventionally, the generator 30 is decoupled from the external current network 35 during the startup and powering down of the turbines of the turbine system, with the resultant disadvantages described above.

In order to attain a more-uniform increase in load during the startup of the turbines of the turbine system and/or a more-uniform reduction in load during powering down, it is necessary to impose an increased braking moment on the turbine; the increase expediently depends on the rpm of the turbine. To that end, in the generator system shown in FIG. 2 and embodied according to the invention, a means for frequency adaptation is disposed, in such a way that it can be put on line, between the generator 30 and the transformer 32. The means for frequency adaptation here is a static frequency converter 40, which is interposed into a bypass line 41. The bypass line 41 branches off from the connecting line 34 upstream of the first disconnection switch 33 and discharges into the connecting line 34 again downstream of the first disconnection switch 33. To enable switching on the current flow through the bypass line 41 as needed and also switching it off again, a second disconnection switch 42 is disposed in the bypass line 41.

During the startup and/or powering down of the turbine system and optionally during other transient, nonsynchronized operating states of the single turbine or multiple turbines of the turbine system as well, the first disconnection switch 33 disposed in the connecting line 34 is open. The direct connection between the generator 30 and the transformer 32 via the connecting line 34 is thus interrupted. However, the second disconnection switch 42 disposed in the bypass line 41 is closed, as a result of which a connection from the generator 30 to the transformer 32 is switched via the bypass line 41 and the static frequency converter 40. In the on-line state, the static frequency converter 40 is operated such that the current generated by the generator 30 is frequency-adapted to the external current network 35. Thus by means of putting the static frequency converter 40 on line, it becomes possible for the current generated by the generator 30 during the startup and/or powering down of the turbine system to be fed into the external current network. Once the turbine system has run up to an rpm that suffices for the synchronization, the static frequency converter 40 is put off-line again. To that end, the second disconnection switch 42 is opened. Simultaneously, the first disconnection switch 33 is closed, so that the connection between the generator 30 and the transformer 32 via the connecting line 34 is established. Upon powering down of the turbine system, the static frequency converter 40 is put off-line upon undershooting of a limit rpm below which the outputting of the generated current into the external current network is not of interest, either for reasons having to do with regulation technology and/or for commercial reasons.

When the current generated by the generator 30 during the startup and/or powering down of the turbine system is output to the external network, the braking moment transmitted to the turbine via the shaft is increased considerably. The increase in the braking moment is largely proportional to the quantity of current output to the external network. The increased braking moment acting on the turbine upon startup of the turbine system prevents a harmful amount of ventilation from developing in the farther-downstream stages of the turbine or in downstream turbines connected to one another via a common shaft. The increase in the load of the turbine system is made more uniform, and no longer in such a steep ramp, especially at the onset of the startup operation, as before. Because the development of ventilation during the startup is prevented, the turbine system can be run up from idling to rated rpm overall in a shorter time. If the turbine system also includes at least one steam turbine, then the steam turbine, because of the more-uniform and overall shortened acceleration, can also be supplied at an earlier time with a greater quantity of steam than in a conventional startup process.

In addition, by the operation according to the invention of the generator system during the startup of the turbine system, current is also carried away into the external current network at an earlier time than in conventional systems. Thus the current can be marketed, which has a commercial advantage in terms of business. The same is analogously true for the process of powering down the turbine system. Since as discussed above the turbine system is at operating speed at an earlier time, the system can already be synchronized at this earlier time as well and thus can be operated to its full extent for generating current in accordance with its rated power. The overall result is greater readiness for use as well as more-flexible use of the entire system. Any bypasses for regulating the flow rate during the startup process may also be smaller or even dispensed with entirely.

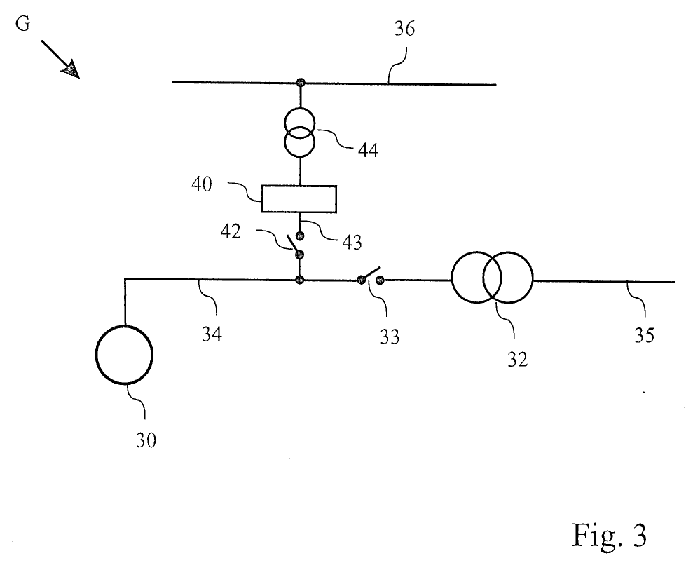

In FIG. 3, a further generator system G embodied according to the invention is shown, which again can be disposed as part of the turbine system shown in FIGS. 1a through 1c.

The generator system G shown in FIG. 3 is embodied similarly to the generator system shown in FIG. 2. However, here the means for frequency adaptation, embodied here as in FIG. 2 as a static frequency converter 40, is disposed not in a bypass line that bypasses the first disconnection switch 33 disposed in the connecting line 34, but rather in a branch line 43 that can be put on line.

To this end, the branch line 43 that can be put on line branches off from the connecting line 34 in a region between the generator 30 and the first disconnection switch 33 and discharges into an internal current network 36. The internal current network 36 serves to supply power to the generator system G or to the entire turbine system and can in a known manner be connected in various ways, in the startup, powering down or normal mode, to the external current network 35, the generator 30, or to some other current supply means.

In order to add on the connection between the connecting line 34 and the internal current network 36 via the branch line 43 as needed and to disconnect it again, a further, second disconnection switch 42 is disposed in the branch line 43. A transformer 44 is also disposed in the branch line 43 here, downstream of the static frequency converter 40, and transforms the frequency-converted current to a voltage level corresponding to the internal current network 36.

The operation of the generator system G shown in FIG. 3 and the attainable improvements, particularly with respect to the startup process and/or the powering down process of the turbine system are equivalent to the description of FIG. 2. Besides the improvements already mentioned above in the operation of the system, the current generated during the startup and/or powering down of the turbine system can here already be fed into the internal power supply before the synchronization of turbine operation. This leads to improved overall profitability of the system.

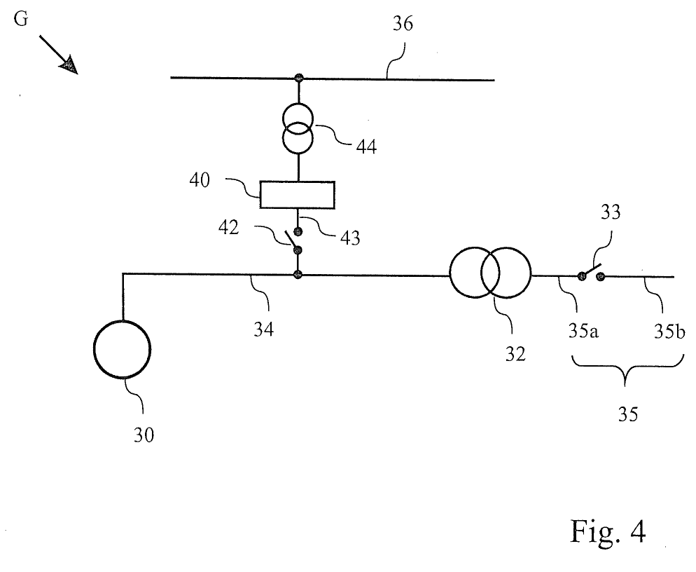

FIG. 4 shows a further generator system G embodied according to the invention. The layout of the generator system G shown in FIG. 4 largely matches the layout of the generator system shown in FIG. 3, so that for its description, reference may be made to the description of FIG. 3. In a distinction from the generator system shown in FIG. 3, the first disconnection switch 33 in FIG. 4 is disposed not in the connecting line 34 between the generator 30 and the transformer 32, but rather in the supply line 35 to the external current network, and hence on the secondary side of the transformer 32. The supply line 35 is thus subdivided in FIG. 4 into the line segments 35a and 35b. The first disconnection switch 33 here is accordingly embodied as a high-voltage switch.

The disposition shown in FIG. 4 is especially suitable for retrofitting generator systems in which the first disconnection switch is not already originally provided in the connecting line 34.

The generator dispositions described in conjunction with FIGS. 2 through 4 represent exemplary embodiments of the invention, which can readily be modified in manifold ways by one skilled in the art without thereby departing from the concept of the invention.

### List of Reference Numerals

1a Turbine system
1b CAES system
1c Steam turbine system
10a, 10b, 10c Turbine
11 Shaft
12 Gas reservoir
13, 13a, 13b, 13c Lines
14 Shutoff valve
15 Line
16 Heat exchanger/recuperator
17, 18 Lines
20 Steam generator
21, 22 Lines
23 Line
24 Condenser
25 Line
26 Condensate pump
27 Line
30 Generator
31 Static frequency converter (sfc)
32 Network transformer
33 Interrupt switch
34, 34a, 34b Current-carrying line
35 Supply line to external current network/external current network
35a, 35b Line segments of supply line 35
36 Internal current network
40 Static frequency converter (sfc)
41 Bypass line
42 Disconnection switch
43 Branch line
44 Transformer
G Generator system

1. A generator system for use in a turbine system, in particular in a CAES system, including
a generator, which for generating current can be drivingly connected to a turbine, and
a transformer, which is connected on the primary side to the generator and on the secondary side can be connected to a current network,
wherein
a means for frequency adaptation is disposed between the generator and the transformer.

2. The generator system of claim 1, wherein the means for frequency adaptation is a frequency converter, in particular a static frequency converter.

3. The generator system of claim 1, wherein the means for frequency adaptation can be put on line.

4. The generator system of claim 1, wherein the generator and the transformer communicate with one another via a connecting line, and a first disconnection element is disposed in the connecting line, and the means for frequency adaptation is disposed in a bypass line that bypasses the first disconnection element, and a second disconnection element is furthermore disposed in the bypass line.

5. The generator system of claim 4, wherein the first and second disconnection elements are disconnection switches.

6. The generator system of claim 1, wherein the generator and the transformer communicate with one another via a connecting line,
and a first disconnection element is disposed in the connecting line,
and the means for frequency adaptation is disposed in a branch line which can be put on line and which branches off from the generator or the connecting line in a region between the generator and the first disconnection element.

7. The generator system of claim 1 wherein the generator and the transformer communicate with one another via a connecting line,
and a first disconnection element is disposed in the supply line to the current network,
and the means for frequency adaptation is disposed in a branch line which can be put on line and which branches off from the generator or the connecting line or the supply line in a region between the generator and the first disconnection element.

8. The generator system of claim 6 of c wherein putting the branch line on line, a second disconnection element is disposed in the branch line.

9. The generator system of claim 6 one of claims 6 wherein the branch line communicates with an internal current network for supplying power to the generator system and/or the turbine system.

10. The generator system of claim 9, wherein a transformer is disposed between the means for frequency adaptation and the internal current network.

11. The generator system of claim 1, wherein the generator is a synchronous generator.

12. A turbine system having at least one turbine, in particular a steam turbine and/or an air turbine, which is drivingly connected to a generator, wherein the generator is embodied as part of the generator system of of claim 1.

13. The turbine system of claim 12, wherein the turbine system is a CAES system.

14. A method for operating a generator system having a generator, which for generating current is driven by at least one turbine of a turbine system, in particular a turbine of a CAES system, wherein the electrical power generated by the generator is frequency-adapted, during a nonsynchronized operating mode of the at least one turbine, before the generated power is carried away into a current network.

15. The method of claim 14, wherein the current network into which the electrical power is carried away is an external current network.

16. The method of claim 14, wherein the current network into which the electrical power is carried away is an internal current network for internal supply to the generator system and/or to the turbine system.

17. The method of claim 14, wherein the nonsynchronized operating mode of the at least one turbine is a startup of the turbine and/or a powering down of the turbine.

18. The method of claim 14, wherein the frequency adaptation upon startup of the turbine is ended after synchronization of the turbine with the external current network has been effected.

19. The method of claim 14, wherein the frequency adaptation upon powering down of the turbine is ended upon undershooting of a limit rpm of the turbine.
